(19) United States
(12) Patent Application Publication
(10) Pub. No.: US 2022/0114296 A1
(43) Pub. Date: Apr. 14, 2022

(54) METHODS, SYSTEMS, AND MEDIA FOR GENERATING BUILDING LAYOUTS

(71) Applicant: Sidewalk Labs LLC, New York, NY (US)

(72) Inventors: Okalo Ikhena, New York, NY (US); Josh Chappell, New York, NY (US); Difei Chen, New York, NY (US); Tess Bianchi, New York, NY (US); Samara Trilling, New York, NY (US); Douwe Osinga, New York, NY (US); Brian Ho, New York, NY (US); Jack Amadeo, New York, NY (US); Luda Zhao, New York, NY (US); David Huang, New York, NY (US); Amelia Harvey, New York, NY (US)

(21) Appl. No.: 17/497,635

(22) Filed: Oct. 8, 2021

Related U.S. Application Data
(60) Provisional application No. 63/089,686, filed on Oct. 9, 2020.

(51) Int. Cl. G06F 30/13; G06F 30/20; G06F 3/14

(52) U.S. Cl. CPC G06F 30/13; G06F 2111/04; G06F 3/14; G06F 30/20

(57) ABSTRACT

Methods, systems, and media for generating building layouts are provided. In some embodiments, the method comprises: receiving building shape information and building constraint information for a layout of a building from a computing device, wherein the building comprises a plurality of floors; generating a central corridor for the building; dividing, for each of the plurality of floors of the building, an area of a floor into a plurality of partitions by creating subdividing lines that connected from the central corridor to an exterior outline of the floor; applying the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and, in response to determining that a stopping criteria has been reached in which the cumulative layout score between a current layout iteration and a previous layout iteration is less than a predetermined threshold value, causing a user interface to be presented on a computing device, wherein the user interface presents the optimized layout of units allocated to each floor of the building.

### CROSS-REFERENCE TO RELATED APPLICATIONS

This application claims the benefit of U.S. Provisional Patent Application No. 63/089,686, filed Oct. 9, 2020, which is hereby incorporated by reference herein in its entirety.

### TECHNICAL FIELD

The disclosed subject matter relates to methods, systems, and media for generating building layouts.

### BACKGROUND

When designing one or more buildings, planners, architects, and developers may want to generate different building layouts while weighing a wide range of competing objectives that impact quality of life. For example, a planner may want to plan for development of buildings in a particular geographic region, such as within a city. In some cases, a development plan may be subject to particular desires or constraints, such as a number of different types of apartments, a maximum height of buildings, etc. For example, when assessing a new development plan, a development team needs to understand whether the development plan can accommodate a certain number of apartments in a particular mix of apartment types and whether the particular mix of apartment types meets the needs of a particular geographic region. In continuing this example, this is crucial for determining whether the development plan is viable and for performing a break-even analysis on the proposed development.

It can be difficult, however, to optimally plan building layouts that optimize quality of units in the building subject to different constraints. Moreover, the time and cost needed to coordinate all of these competing elements often means a project can only afford to develop a handful of building layouts for the project team.

Accordingly, it is desirable to provide new methods, systems, and media for generating building layouts.

### SUMMARY

Methods, systems, and media for generating building layouts are provided.

In accordance with some embodiments of the disclosed subject matter, a method for building layout generation is provided, the method comprising: receiving, using a hardware processor, building shape information and building constraint information for a layout of a building from a computing device, wherein the building comprises a plurality of floors; generating, using the hardware processor, a central corridor for the building; dividing, using the hardware processor, for each of the plurality of floors of the building, an area of a floor into a plurality of partitions by creating subdividing lines that connected from the central corridor to an exterior outline of the floor; applying, using the hardware processor, the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and, in response to determining that a stopping criteria has been reached in which the cumulative layout score between a current layout iteration and a previous layout iteration is less than a predetermined threshold value, causing, using the hardware processor, a user interface to be presented on a computing device, wherein the user interface presents the optimized layout of units allocated to each floor of the building.

In some embodiments, the building shape information includes geometric information of the building and the building constraint information includes a number of types of different units that are to be included in the building.

In some embodiments, the method further comprises determining unit mix information for the building based on location information of the building.

In some embodiments, the plurality of partitions are constructed such that a center of a first partition is a particular distance from a center of a second partition that is adjacent to the first partition and the first partition and the second partition have different areas.

In some embodiments, the area of the floor is allocated into units by combining partitions having an area greater than a particular threshold to generate a set of first units and successively combining remaining partitions having an area less than the particular threshold to generate a set of second units.

In some embodiments, the area of the floor is allocated into units based on one or more adjacency factors indicating a preference to allocate particular unit types.

In some embodiments, the method further comprises determining an estimate occupancy of the floor of the building, wherein the area of the floor is allocated into units based on expected noise conditions for the estimated occupancy of the floor.

In some embodiments, the lighting sub-score is generated using a lighting model that projects light from a particular direction at a particular point corresponding to the unit.

In some embodiments, the score for each unit in the building is generated based on a location quality of a unit that incorporates a floor of the building that the unit is in and a location of the building that the unit is in.

In some embodiments, the user interface presents a progression of the layouts of the building over a plurality of iterations of the optimization function.

In accordance with some embodiments of the disclosed subject matter, a system for building layout generation is provided, the system comprising a hardware processor that is configured to: receive building shape information and building constraint information for a layout of a building from a computing device, wherein the building comprises a plurality of floors; generate a central corridor for the building; divide, for each of the plurality of floors of the building, an area of a floor into a plurality of partitions by creating subdividing lines that connected from the central corridor to an exterior outline of the floor; apply the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combining the score for each unit of the floor in the building to generate a cumulative layout score for generated layouts including the allocated units in the building; and, in response to determining that a stopping criteria has been reached in which the cumulative layout score between a current layout iteration and a previous layout iteration is less than a predetermined threshold value, cause a user interface to be presented on a computing device, wherein the user interface presents the optimized layout of units allocated to each floor of the building.

In accordance with some embodiments of the disclosed subject matter, a non-transitory computer-readable medium containing computer executable instructions that, when executed by a processor, cause the processor to perform a method for building layout generation is provided, the method comprising: receiving building shape information and building constraint information for a layout of a building from a computing device, wherein the building comprises a plurality of floors; generating a central corridor for the building; dividing, for each of the plurality of floors of the building, an area of a floor into a plurality of partitions by creating subdividing lines that connected from the central corridor to an exterior outline of the floor; applying the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combining the score for each unit of the floor in the building to generate a cumulative layout score for generated layouts including the allocated units in the building; and, in response to determining that a stopping criteria has been reached in which the cumulative layout score between a current layout iteration and a previous layout iteration is less than a predetermined threshold value, causing a user interface to be presented on a computing device, wherein the user interface presents the optimized layout of units allocated to each floor of the building.

In accordance with some embodiments of the disclosed subject matter, a system for building layout generation is provided, the system comprising: means for receiving building shape information and building constraint information for a layout of a building from a computing device, wherein the building comprises a plurality of floors; means for generating a central corridor for the building; means for dividing, for each of the plurality of floors of the building, an area of a floor into a plurality of partitions by creating subdividing lines that connected from the central corridor to an exterior outline of the floor; means for applying the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and means for causing a user interface to be presented on a computing device in response to determining that a stopping criteria has been reached in which the cumulative layout score between a current layout iteration and a previous layout iteration is less than a predetermined threshold value, wherein the user interface presents the optimized layout of units allocated to each floor of the building.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative process for generating building layouts in accordance with some embodiments of the disclosed subject matter.

FIGS. 2A and 2B show illustrative examples of user interfaces for presenting building layouts in accordance with some embodiments of the disclosed subject matter.

FIGS. 3A and 3B show illustrative examples of user interfaces for presenting scores for units in buildings in accordance with some embodiments of the disclosed subject matter.

FIG. 4 shows a schematic diagram of an illustrative system suitable for implementation of mechanisms described herein for generating building layouts in accordance with some embodiments of the disclosed subject matter.

FIG. 5 shows a detailed example of hardware that can be used in a server and/or a user device of FIG. 4 in accordance with some embodiments of the disclosed subject matter.

### DETAILED DESCRIPTION

In accordance with various embodiments, mechanisms (which can include methods, systems, and media) for generating building layouts are provided.

In some embodiments, the mechanisms described herein can be used to generate building layouts. For example, in some embodiments, the mechanisms described herein can be used to allocate units (e.g., apartments, commercial space, storage space, and/or any other suitable units) within buildings. In some embodiments, the mechanisms can allocate units in buildings subject to any suitable constraints. For example, in some embodiments, the constraints can indicate that a proportion of units and/or a proportion of total square footage are to be units of a particular type (e.g., 20% of units are to be two-bedroom apartments, 10% of the total square footage of a building or a group of buildings is to be commercial space, and/or any other suitable type of unit constraint). In another example, in some embodiments, the constraints can indicate that a building has irregularly shaped floorplans for each floor of the building and can indicate that a proportion of units that each fall within a particular square footage range (e.g., 50% of the units in the irregularly shaped floorplan are to be one-bedroom apartments that are between 400 square feet and 550 square feet based on average square footage of a one-bedroom apartment in the New York area). In yet another example, in some embodiments, the constraints can indicate a particular estimated occupancy that a building having the proposed building layouts must achieve.

In some embodiments, each unit can be assigned a score that indicates a quality or a value of the unit. For example, in some embodiments, the score of a unit can be based on an amount of light received by the unit, an amount of shadow received by the unit, a quality of the location of the unit (e.g., based on a floor of the building the unit is in, based on a location of the building the unit is in, and/or any other suitable location), and/or any other suitable factors. In some embodiments, a cumulative score that indicates a quality of a layout that includes multiple buildings each having multiple units can be generated based on the scores for each unit and a total area covered by the units in all of the buildings. In some embodiments, the cumulative score can then be used as a function to be optimized using an optimization algorithm, where a new layout of buildings and units in buildings is generated at each iteration of the optimization algorithm.

In some embodiments, by generating building layouts using an optimization algorithm, layouts that optimize both unit quality and total available area can be generated that are subject to any suitable constraints (e.g., that units must have a minimum quality, that a predetermined proportion of units must be of a particular type, and/or any other suitable constraints). For example, in some embodiments, over successive iterations, a layout that generates buildings that are tall enough to include more than a predetermined number of units and/or more than a predetermined total square footage can be generated such that a particular building is not so tall that it generates shadows that would lower a quality of units in adjacent or nearby buildings located in the shadows. In another example, in some embodiments, over successive iterations, a layout that generates buildings that are tall enough to include more than a predetermined number of units and/or more than a predetermined number of occupants can be generated such that a particular building generates at least a particular amount of revenue while not being so tall that it generates shadows that would lower a quality of units in adjacent or nearby buildings located in the shadows.

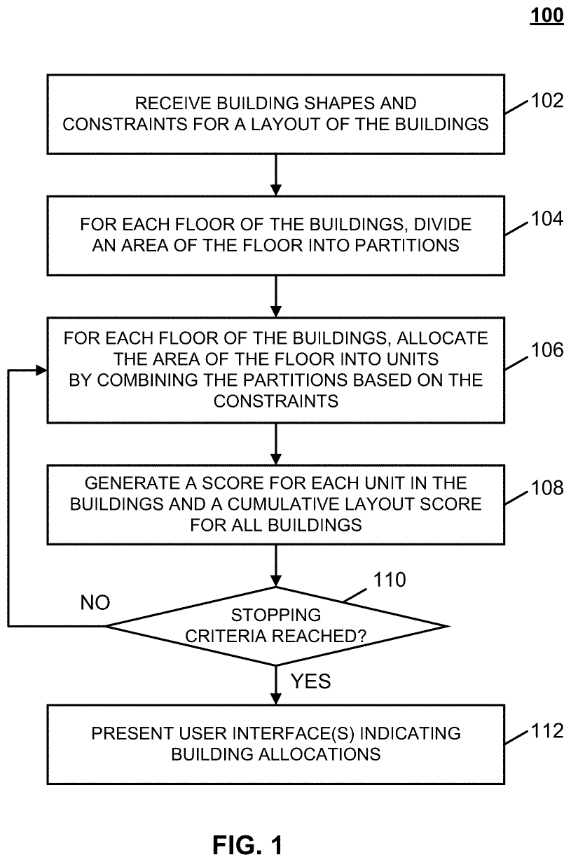

These and other features for generating a layout of units in a building and generating scores for each unit in the building are described in connection with FIGS. 1-5.

Turning to FIG. 1, an illustrative example 100 of a process for generating building layouts is shown in accordance with some embodiments of the disclosed subject matter. In some embodiments, process 100 can be executed by any suitable device such as a server or a user device (e.g., a desktop computer, a laptop computer, and/or any other suitable type of user device). Note that, in some embodiments, in an instance in which blocks of process 100 are executed by a server, any suitable input parameters can be received at the server from a user device. Additionally, in some such embodiments, user interfaces can be presented on the user device.

Process 100 can begin at 102 by receiving building shapes and constraints for one or more buildings. In some embodiments, process 100 can receive information for any suitable number of buildings (e.g., one, two, ten, twenty, and/or any other suitable number). In some embodiments, the building shape information can include any suitable information about a geometry of a building, such as dimensions of the building (e.g., a building size, a building shape, and/or any other suitable building dimension information), dimensions of inner corridors of the building (e.g., a width of the inner corridors), locations of elevators or stairwells, and/or any other suitable building shape information. In some embodiments, the building shape information can include information for different floors of a building. For example, the building shape information can indicate that a first floor of the building has a first square footage, and a second floor of the building has a second square footage that is different than the first square footage.

Note that, in some embodiments, process 100 can receive the building shape information from any suitable source. For example, in some embodiments, process 100 can generate the building shape based on any suitable criteria, such as that the building is to have a particular number of floors or is to have particular dimensions. Note that, in some such embodiments, process 100 can generate the building shape as part of the optimization algorithm described below in connection with blocks 106-110. As another example, in some embodiments, process 100 can receive the building shape information from any suitable source, such as from a remote database that stores building information.

In some embodiments, the building constraint information can include any suitable constraints. For example, in some embodiments, the building constraint information can include constraints related to a number of types of different units that are to be included in a particular building. As a more particular example, in some embodiments, the building constraint information can include information indicating that a particular number of commercial units are to be included, that a particular number of studio apartments are to be included, that a particular number of one-bedroom apartments are to be included, that a particular number of two-bedroom apartments are to be included, that a particular number of storage spaces are to be included, and/or any other suitable information. Note that, rather than specifying a particular number of units of a particular type, in some embodiments, the building constraint information can indicate that a particular percentage of units are to be of a particular type (e.g., 50% of the units are to be one-bedroom units, 30% of the units are to be studio apartments, etc.). In continuing this example, process 100 can retrieve common unit mix information in a particular geographic location (e.g., that a building in the New York region tends to have a particular mix of apartment units) and can determine whether one or more generated building layouts comply with the common unit mix information in a particular geographic location. As another example, in some embodiments, the building constraint information can indicate that particular types of units are to be a particular size and/or within a particular size range. As a more particular example, in some embodiments, the building constraint information can indicate that a studio apartment is to be between 400 square feet and 500 square feet. As yet another example, in some embodiments, the building constraint information can indicate a number of units that are to have access to outdoor space, such as a balcony. As still another example, in some embodiments, the building constraint information can indicate that units of a particular type (e.g., storage units, one-bedroom units, and/or any other suitable type of unit) are to be stacked on successive floors within a building. As still another example, in some embodiments, the building constraint information can indicate a thickness of interior walls of the building that separate units.

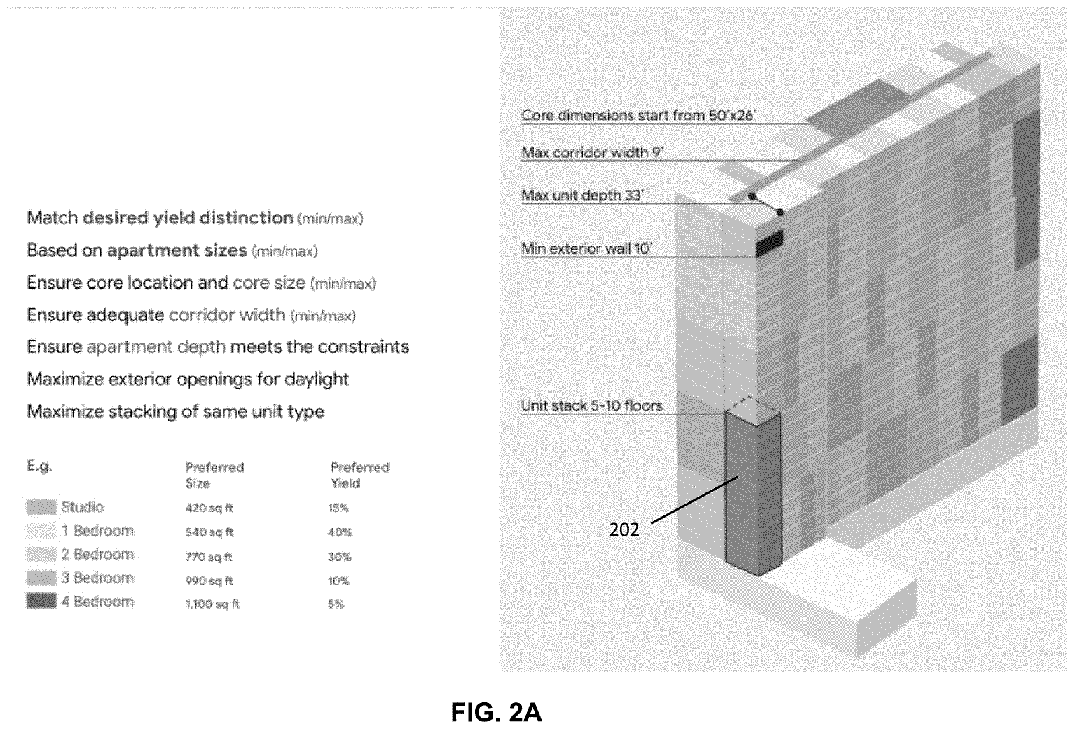

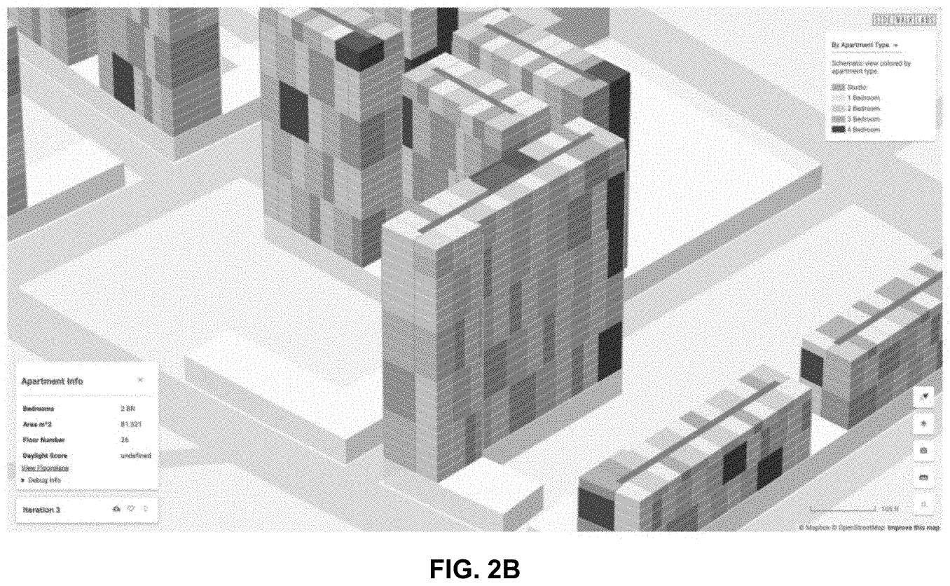

In a more particular example, FIG. 2A shows an illustrative example of building constraint information that can be received at 102 of FIG. 1. For example, as shown in FIG. 2A, such building constraint information can include dimension information such as a minimum exterior wall dimension of 10 feet, a maximum unit depth of 33 feet, a maximum corridor width of 9 feet, core dimensions that begin from 50 feet by 26 feet. In another example, as also shown in FIG. 2A, the building constraint information can also indicate that apartment units are to be stacked for a particular minimum number of floors, a particular maximum number of floors, or within a range of floors. In continuing this example, the unit stack information can vary based on building location, such as at least five floors having the same apartment stack on lower levels of a building and at least three floors having the same apartment stack on upper levels of the building. It should be noted that a user interface, such as the one shown in FIG. 2A, can be provided for inputting building shape and/or building constraint information. As such, the building constraint information can be modified (e.g., by a user on a development team) in order to customize the resulting apartment or building layouts.

In another more particular example, FIG. 2B shows an illustrative example of building constraint information that can be received at 102 for an individual building or for a development containing multiple buildings. It should be noted that a set of building constraint information can be received for one of the buildings in FIG. 2B and a different set of building constraint information can be received for another one of the buildings in FIG. 2B.

It should be noted that, in some embodiments, the building constraint information can include a minimum estimated occupancy for a building having a proposed layout and unit allocation. For example, in response to a break-even analysis indicating that a building of a particular shape and size and located in a particular geographic location needs to house at least 250 occupants in order to break even, a user of a development team can input a minimum estimated occupancy of 250 for generating proposed layouts of the building. In response, as a generative design system implementing the mechanisms described herein generates a proposed layout having a particular unit allocation for the building, the generative design system can calculate an estimated occupancy given the proposed unit allocation for the building (e.g., upon estimating that 1.2 persons occupy a studio apartment and 1.8 persons occupy a 1-bedroom apartment in the New York region and upon generating a proposed layout with 100 studio apartments and 100 1-bedroom apartments, the estimated occupancy is 300 occupants). In continuing this example, the generative design system can then determine whether the estimated occupancy for the proposed layout meets the building constraints of unit mix and minimum estimated occupancy.

At 104, process 100 can, for each floor of each of the buildings, divide an area of the floor into partitions. In some embodiments, the partitions can have any suitable size (e.g., 3 square meters, 5 square meters, and/or any other size) and any suitable shape (e.g., squares, rectangles, etc.) such that a unit can be constructed by tiling together multiple partitions. In some embodiments, process 100 can select a size and/or shape of the partitions based on a size or dimensions of the floor of the building. Note that, in some embodiments, each partition can have the same size.

In a more particular implementation, process 100 can generate a central corridor for a building. Process 100 can then partition a floor of the building by creating subdividing lines that connect from the previously generated central corridor to the facade or exterior outline of the floor, thereby generating multiple partitions for the floor of the building. As these partitions may have a size less than a resulting unit (e.g., 3 square meters, 5 square meters, and/or any other size), process 100 can assemble the partitions to create multiple units for the floor of the building that meet the building constraint information. It should be noted that this can allow for the floor outline and the central corridor to be generated separately.

Alternatively, in some embodiments, partitions of a floor can have different sizes. For example, in some such embodiments, partitions can be constructed such that a center of a first partition is a particular distance from a center of a second, neighboring partition, and such that the first partition and the second partition have different areas.

Blocks 106 and 108 describe allocating units of buildings and generating scores for the units and buildings after allocation. In some embodiments, blocks 106 and 108 can be performed iteratively as part of an optimization algorithm using the constraints described in 102 (e.g., a linear optimization algorithm, and/or any other suitable optimization algorithm). For example, in some embodiments, the score(s) generated at 108 can be used as a function that is to be optimized by the optimization algorithm over successive iterations.

At 106, process 100 can, for each floor of each of the buildings, allocate the area of the floor into units by combining the partitions subject to the constraints described above in connection with 102. In some embodiments, process 100 can allocate the area of the floor into units in any suitable manner and using any suitable technique(s). For example, in some embodiments, process 100 can use any suitable algorithm to partition the floor into units (e.g., into apartments, into commercial space, into storage space, into miscellaneous space, and/or any other suitable units). As a more particular example, in some embodiments, process 100 can use a greedy algorithm that combines partitions to generate units corresponding to the largest areas first, and can successively combine remaining partitions to generate units with smaller areas. As a specific example, in some embodiments, for a floor having 10,000 square feet, process 100 can: 1) combine partitions to generate five two-bedroom apartments having 1000 square feet each; 2) combine remaining partitions to generate five one-bedroom apartments having 700 square feet each; and 3) combine remaining partitions to generate three studio apartments having 500 square feet each.

In some embodiments, process 100 can allocate the units subject to the constraints described above in connection with 102. For example, in some embodiments, process 100 can determine whether an allocation of units using a greedy algorithm as described above satisfies the constraints. As a more particular example, in an instance in which the greedy algorithm generates a floor layout with ten apartments, of which five are two-bedroom units, and in which the building constraints indicate that a floor can have at most 10% of the units be two-bedroom units, process 100 can determine that the current floor layout does not satisfy the constraints. As another example, in some embodiments, process 100 can determine, after allocating units in an entire building and/or in several buildings, whether the allocation satisfies the constraints. As a more particular example, in an instance in which the constraints indicate that at most 10% of a building can include two-bedroom units, and in which a building layout includes twenty two-bedroom units out of one hundred total units, process 100 can determine that the current building layout does not satisfy the constraints. In some embodiments, process 100 can re-allocate a floor layout or a building layout in response to determining that a current layout does not satisfy the constraints.

In some embodiments, process 100 can allocate the units based on one or more adjacency factors. For example, process 100 can allocate the units in a building based on an adjacency factor indicating a preference to allocate certain unit types together due to mechanical, electrical, and/or plumbing placement. In a more particular example, one-bedroom apartments can be stacked in a particular portion of a building to accommodate a plumbing chase wall such that pipes and other plumbing can run from a particular portion of the building (e.g., the top floor) to another portion of the building (e.g., the basement of the building). In another example, process 100 can determine an estimated occupancy of a floor of the building and can allocate the units on the particular floor based on expected noise conditions. Any other suitable adjacency factor can be considered by the generative design system executing the mechanisms described herein when allocating the units of a building.

In some embodiments, process 100 can allocate the units subject to the constraints described above in connection with 102, which include a minimum estimated occupancy for a building having a proposed layout and unit allocation. For example, in response to a break-even analysis indicating that a building of a particular shape and size and located in a particular geographic location needs to house at least 250 occupants in order to break even, a user of a development team can input a minimum estimated occupancy of 250 for generating proposed layouts of the building. In response, a generative design system executing process 100 can calculate an estimated occupancy given the proposed unit allocation for the building (e.g., upon estimating that 1.2 persons occupy a studio apartment and 1.8 persons occupy a 1-bedroom apartment in the New York region and upon generating a proposed layout with 100 studio apartments and 100 1-bedroom apartments, the estimated occupancy is 300 occupants) and can determine whether the estimated occupancy given the proposed unit allocation for the building meet the minimum estimated occupancy constraint.

Turning to FIGS. 2A and 2B, example schematic diagrams of allocations of units in buildings are shown in accordance with some embodiments of the disclosed subject matter. As illustrated in FIG. 2A, units can be allocated such that units of a particular type are stacked, such as in stack 202. For example, continuing the above example, stack 202 can extend from the lowest floor to the highest floor of the building to accommodate a plumbing chase wall such that pipes and other plumbing can extend between the lowest floor of the building and the highest floor of the building. As illustrated in FIG. 2B, units can be allocated across multiple buildings, as described above in connection with 106 of FIG. 1.

Referring back to FIG. 1, at 108, process 100 can generate a score for each unit in each of the buildings. In some embodiments, the score can indicate a value of the unit. In some embodiments, the score can be based on any suitable criteria. For example, in some embodiments, the criteria can include lighting effects of the unit, such as an amount of daylight the unit receives (e.g., at a particular test point on a facade of the building, and/or at any other suitable place), an amount of shadow cast on the unit from nearby structures, whether the unit faces a particular cardinal direction, and/or any other suitable lighting effects. As a specific example, a unit that receives a relatively large amount of light can receive a relatively higher score for lighting effects than a unit that receives a relatively smaller amount of light. As another example, in some embodiments, the criteria can include relative location of the unit, such as information indicating a quality of a view from the unit (e.g., a view of water, a view of mountains, a view of a historical landmark, and/or any other suitable view), information indicating proximity or walkability to different locations (e.g., grocery stores, schools, parks, restaurants, coffee shops, movie theatres, and/or any other suitable locations of interest), and/or any other suitable location or convenience information. As a specific example, in some embodiments, a unit that is in a building with greater proximity to nearby locations (i.e., is more walkable) can receive a relatively higher location score than a unit that is in a building that is farther from nearby locations. As another specific example, in some embodiments, a unit that is on a higher floor of a building can receive a relatively higher location score than a unit that is on a lower floor of the building due to having a better view. In some embodiments, a score for a unit can combine sub-scores associated with different criteria or factors in any suitable manner, for example, by generating a weighted average of the sub-scores. In some embodiments, sub-scores can be normalized in any suitable manner (e.g., along a predetermined gradient of value, and/or in any other suitable manner).

Note that, in some embodiments, measurements used to calculate a particular sub-score can be generated in any suitable manner. For example, in some embodiments, a lighting effects sub-score can be generated using any suitable model that projects light from a particular direction at a particular point corresponding to the unit. As another example, in some embodiments, a location sub-score can be generated by calculating an average distance of a building a particular unit is to different locations of interest.

In some embodiments, scores can be categorized in any suitable manner. For example, in some embodiments, a numeric score can be categorized (e.g., into category scores of “Grade A,” “Grade B,” “Grade C,” and/or “Grade D”) based on any suitable thresholds. As a more particular example, in some embodiments, scores that are more than 90% of a full possible score can be assigned “Grade A;” scores that are between 75% and 90% of a full possible score can be assigned “Grade B;” scores that are between 45% and 75% of a full possible score can be assigned “Grade C;” and scores that are below 45% of a full possible score can be assigned “Grade D.”

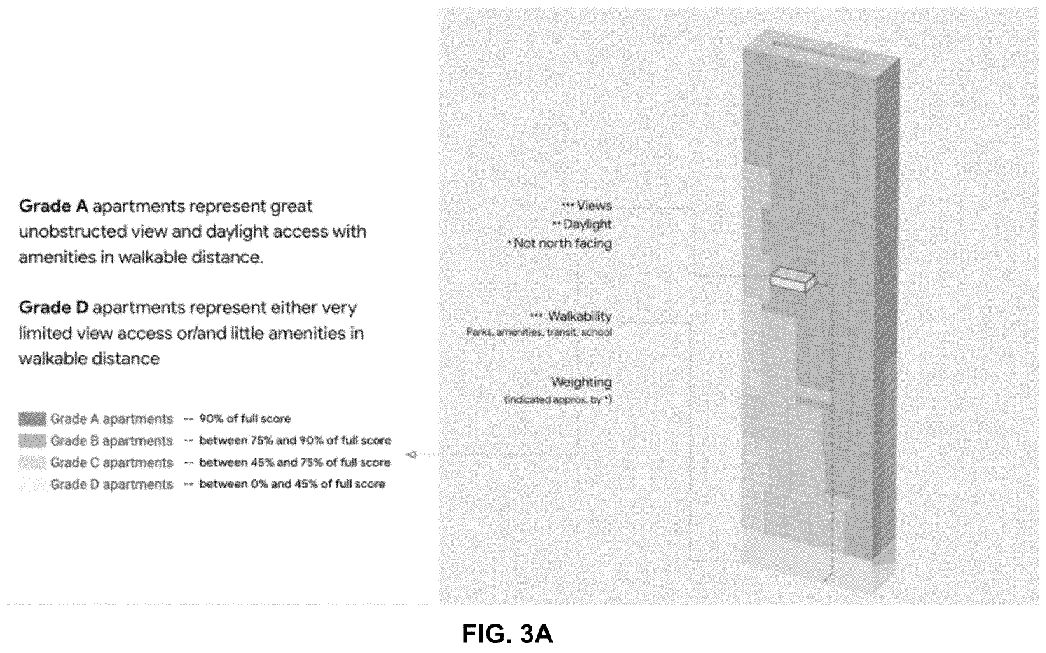

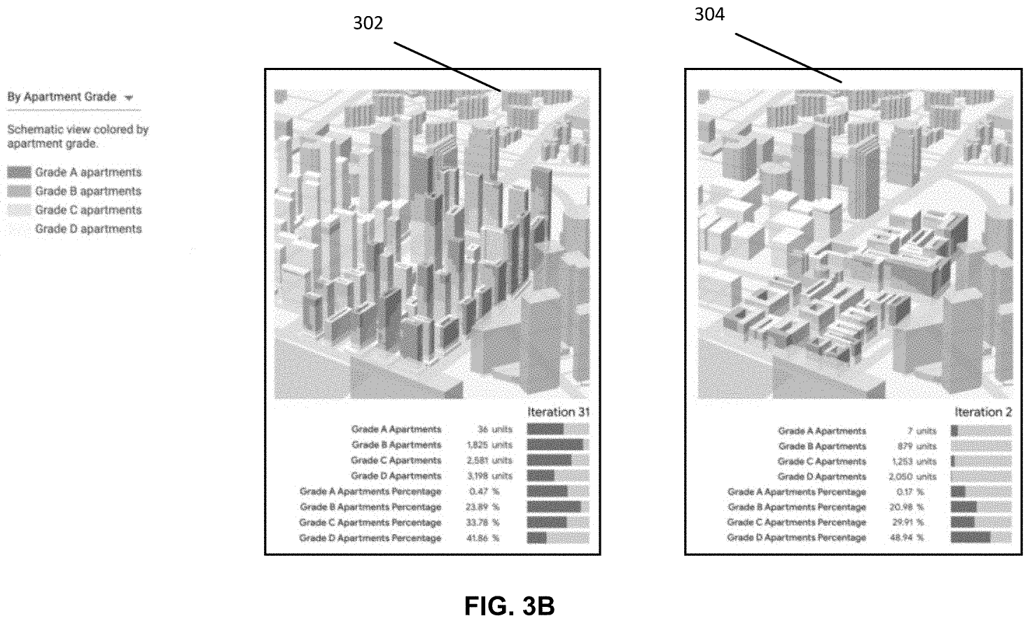

Turning to FIG. 3A, an example schematic diagram of scoring of units in a building is shown in accordance with some embodiments of the disclosed subject matter. For example, as shown in FIG. 3A, the schematic diagram can highlight each unit in the building based on the calculated score or based on a score category—e.g., “Grade A” scored-units representing units having unobstructed views and daylight access with amenities within a walkable distance can be shaded a darker color in the schematic diagram while “Grade D” scored-units representing units having either limited view access and/or few amenities within a walkable distance can be shaded a lighter color in the schematic diagram.

Referring back to FIG. 1, in some embodiments, process 100 can then generate a cumulative score for the generated layouts across all of the buildings based on the individual scores of each apartment. In some embodiments, the cumulative score can indicate any suitable information that aggregates scores or grade corresponding to individual units, such as an average score or grade of the units across all of the buildings, a percentage of units that exceed a particular score or grade (e.g., a percentage of units that are categorized as Grade B or higher), a percentage of units that are categorized in the poorest category (e.g., Grade D, and/or any other suitable category). In some embodiments, the cumulative score can indicate a total usage area generated by the particular layouts. For example, in some embodiments, the cumulative score can indicate a total square footage of all of the units included in the layouts of all of the buildings. In some embodiments, process 100 can generate the cumulative score by combining an aggregate indication of unit quality (e.g., the scores for each unit) with the total usage area in any suitable manner, such as a weighted average, and/or in any other suitable manner. In some embodiments, the cumulative score can indicate an aggregate quality of the building layouts.

It should be noted that, in accordance with some embodiments, scores for each unit in a building, scores for a building based on the individual scores of each unit, and/or cumulative scores for layouts across buildings based on the individual scores of each building can be generated without the unit allocation features in generating a building layout described above. For example, process 100 can receive unit information, layout information, building information, and any other suitable information and can generate one or more of these scores based on such information.

At 110, process 100 can determine whether a stopping criteria for the optimization algorithm corresponding to blocks 106 and 108 has been reached. In some embodiments, any suitable stopping criteria can be used, such as that a cumulative score for the allocations (e.g., as calculated in and described above in connection with 108) has changed by less than a predetermined threshold (e.g., by less than 1%, by less than 0.1%, and/or any other suitable threshold) between the current iteration and the previous iteration, that a predetermined number of iterations (e.g., fifty, one hundred, one thousand, and/or any other suitable number) of the optimization algorithm have been run, and/or any other suitable criteria.

If, at 110, process 100 determines that the stopping criteria have not been reached (“no” at 110), process 100 can loop back to 106 and can re-allocate units of each of the floors of each of the buildings. Note that, in some embodiments, in an instance in which process 100 generates a building shape or geometry in addition to allocating units, process 100 can first modify a shape of each building (e.g., make a building taller, make a building shorter, make a building wider, make a building more narrow, and/or modify a building in any other suitable manner).

If, at 110, process 100 determines that the stopping criteria have been reached, process 100 can proceed to 112, and can present user interfaces indicating the building allocations.

For example, as shown in FIGS. 2A and 2B, the user interfaces can indicate unit sizes or types within each building. As another example, in some embodiments, the user interfaces can indicate scores or grades of each unit, as shown in and described above in connection with FIG. 3A.

In some embodiments, a user interface can be interacted with in any suitable manner. For example, in an instance in which the user interface presents information related to multiple buildings, an individual building can be selected, and information pertaining to the selected building can be presented (e.g., information indicating numbers of units of different types, information indicating scores for each unit in the building, information indicating sub-scores relating to different criteria for each unit in the building, and/or any other suitable information). As another example, in an instance in which the user interface presents information related to multiple buildings as a map (e.g., where different buildings are located along particular streets of a geographic region), the map can be interacted with in any suitable manner. As a more particular example, particular regions of the map can be zoomed in or expanded. As another particular example, in some embodiments, the map can be rotated such that a view of the geographic region can be presented from a different cardinal direction viewpoint.

In connection with 102 of FIG. 1 in which the user interface presents building constraint information or other development information, one or more buildings can be selected and building constraint information or other development information can be presented and can be modified by the user. For example, the user using the user interface can present building constraint information or other development information in the form of user-adjustable parameters. In a more particular example, FIG. 2A shows an illustrative example of building constraint information that can be received at 102 of FIG. 1. For example, as shown in FIG. 2A, such building constraint information can include dimension information such as a minimum exterior wall dimension of 10 feet, a maximum unit depth of 33 feet, a maximum corridor width of 9 feet, core dimensions that begin from 50 feet by 26 feet. In another example, as also shown in FIG. 2A, the building constraint information can also indicate that apartment units are to be stacked for a particular minimum number of floors, a particular maximum number of floors, or within a range of floors. In continuing this example, the unit stack information can vary based on building location, such as at least five floors having the same apartment stack on lower levels of a building and at least three floors having the same apartment stack on upper levels of the building. The user interface, such as the one shown in FIG. 2A, can be provided for inputting and/or adjusting the building constraint information. As such, the building constraint information can be modified (e.g., by a user on a development team) in order to customize the resulting apartment or building layouts.

In another more particular example, FIG. 2B shows an illustrative example of building constraint information that can be received at 102 for an individual building or for a development containing multiple buildings. It should be noted that a set of building constraint information can be received for one of the buildings in FIG. 2B and a different set of building constraint information can be received for another one of the buildings in FIG. 2B.

In some embodiments, user interfaces can be presented that show a progression of the layouts of buildings over multiple iterations of the optimization algorithm, as shown in FIG. 3B. For example, as shown in FIG. 3B, allocation 302 shows a layout output after iteration 31, and allocation 304 shows a layout output after iteration 2. As shown in FIG. 3B, each allocation can indicate a distribution of scores of units in the allocation (e.g., as a histogram, and/or in any other suitable manner), thereby showing how the allocation has improved from the earlier iteration to the later iteration.

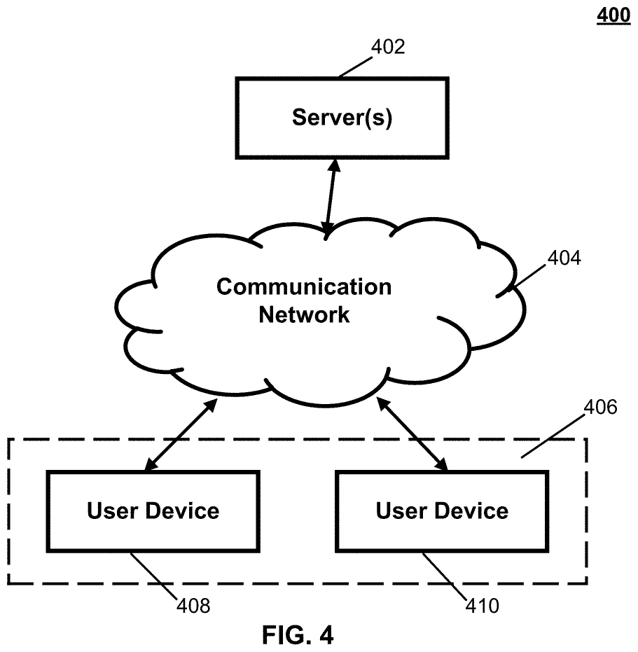

Turning to FIG. 4, an example 400 of hardware for generating building layouts that can be used in accordance with some embodiments of the disclosed subject matter is shown. As illustrated, hardware 400 can include a server 402, a communication network 404, and/or one or more user devices 406, such as user devices 408 and 410.

In some embodiments, server 402 can be any suitable server for storing data and/or programs, executing programs (e.g., executing an algorithm to generate building layouts, as described above in connection with FIG. 1), and/or for any other suitable function(s). For example, in some embodiments, server 402 can store geographic information for a particular region, such as locations of water (e.g., lakes, rivers, etc.), geographic borders, topographic information, and/or any other suitable type of geographic information that can be used for generating building layouts. In a more particular example, server 402 can store common unit mix information in a particular geographic location (e.g., that a building in the New York region tends to have a particular mix of apartment units, that a one-bedroom apartment in the New York region is generally between 400 square feet and 700 square feet in size while a one-bedroom apartment in the Phoenix region is generally between 600 square feet and 1,000 square feet in size, etc.). As another example, in some embodiments, server 402 can store a program used to generate building layouts, as described above in connection with FIG. 1. Note that, in instances in which server 402 executes a program or an algorithm to generate building layouts, server 402 can receive any suitable input parameters or instructions from user device 406. In some embodiments, server 402 can be omitted.

Communication network 404 can be any suitable combination of one or more wired and/or wireless networks in some embodiments. For example, communication network 404 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 406 can be connected by one or more communications links to communication network 404 that can be linked via one or more communications links to server 402. The communications links can be any communications links suitable for communicating data among user devices 406 and server 402, such as network links, dial-up links, wireless links, hard-wired links, any other suitable communications links, or any suitable combination of such links.

User devices 406 can include any one or more user devices suitable for storing data or programs, executing programs, transmitting input parameters or instructions to server 402, presenting user interfaces that indicate building layouts (e.g., as shown in and described above in connection with FIGS. 2A, 2B, 3A, and 3B), and/or for performing any other suitable function(s). For example, in some embodiments, user devices 406 can include a desktop computer, a laptop computer, a mobile phone, a tablet computer, and/or any other suitable type of user device.

Although server 402 is illustrated as one device, the functions performed by server 402 can be performed using any suitable number of devices in some embodiments. For example, in some embodiments, multiple devices can be used to implement the functions performed by server 402.

Although two user devices 408 and 410 are shown in FIG. 4 to avoid over-complicating the figure, any suitable number of user devices, and/or any suitable types of user devices, can be used in some embodiments.

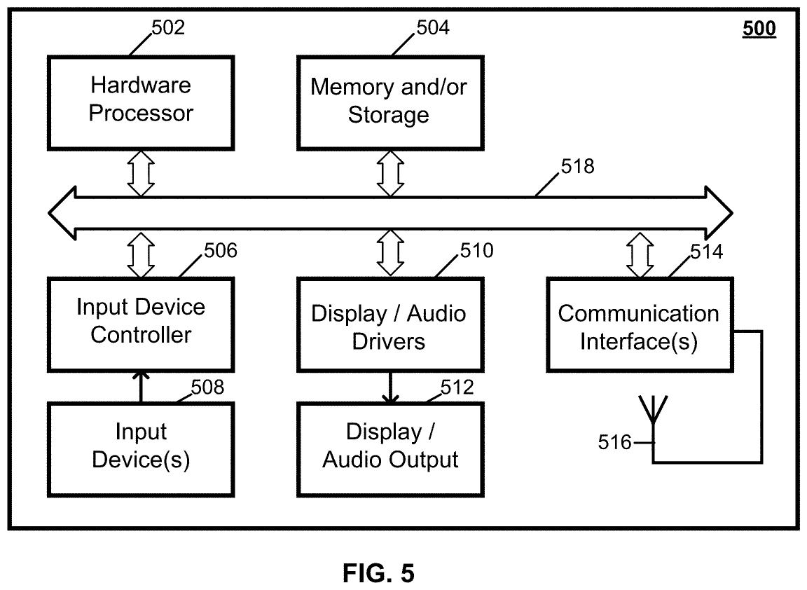

Server 402 and user devices 406 can be implemented using any suitable hardware in some embodiments. For example, in some embodiments, server 402 and user devices 406 can be implemented using any suitable general purpose computer or special purpose computer. For example, a mobile phone may be implemented using a special purpose computer. Any such general purpose computer or special purpose computer can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 514, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 502 can be controlled by a server program stored in memory and/or storage of a server, such as server 402. In some embodiments, hardware processor 502 can be controlled by a computer program stored in memory and/or storage 504 of user device 406.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some embodiments. For example, input device controller 506 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 510 can be any suitable circuitry for controlling and driving output to one or more display/audio output devices 512 in some embodiments. For example, display/audio drivers 510 can be circuitry for driving a touchscreen, a flat-panel display, a cathode ray tube display, a projector, a speaker or speakers, and/or any other suitable display and/or presentation devices.

Communication interface(s) 514 can be any suitable circuitry for interfacing with one or more communication networks (e.g., computer network 404). For example, interface(s) 514 can include network interface card circuitry, wireless communication circuitry, and/or any other suitable type of communication network circuitry.

Antenna 516 can be any suitable one or more antennas for wirelessly communicating with a communication network (e.g., communication network 404) in some embodiments. In some embodiments, antenna 516 can be omitted.

Bus 518 can be any suitable mechanism for communicating between two or more components 502, 504, 506, 510, and 514 in some embodiments.

Any other suitable components can be included in hardware 500 in accordance with some embodiments.

In some embodiments, at least some of the above described blocks of the processes of FIG. 1 can be executed or performed in any order or sequence not limited to the order and sequence shown in and described in connection with the figure. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for generating building layouts are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for building layout generation, the method comprising:
receiving, using a hardware processor, building shape information and building constraint information for a layout of a building from a computing device, wherein the building comprises a plurality of floors;
generating, using the hardware processor, a central corridor for the building;
dividing, using the hardware processor, for each of the plurality of floors of the building, an area of a floor into a plurality of partitions by creating subdividing lines that connected from the central corridor to an exterior outline of the floor;
applying, using the hardware processor, the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and
in response to determining that a stopping criteria has been reached in which the cumulative layout score between a current layout iteration and a previous layout iteration is less than a predetermined threshold value, causing, using the hardware processor, a user interface to be presented on a computing device, wherein the user interface presents the optimized layout of units allocated to each floor of the building.

2. The method of claim 1, wherein the building shape information includes geometric information of the building and the building constraint information includes a number of types of different units that are to be included in the building.

3. The method of claim 1, further comprising determining unit mix information for the building based on location information of the building.

4. The method of claim 1, wherein the plurality of partitions are constructed such that a center of a first partition is a particular distance from a center of a second partition that is adjacent to the first partition and wherein the first partition and the second partition have different areas.

5. The method of claim 1, wherein the area of the floor is allocated into units by combining partitions having an area greater than a particular threshold to generate a set of first units and successively combining remaining partitions having an area less than the particular threshold to generate a set of second units.

6. The method of claim 1, wherein the area of the floor is allocated into units based on one or more adjacency factors indicating a preference to allocate particular unit types.

7. The method of claim 1, further comprising determining an estimate occupancy of the floor of the building, wherein the area of the floor is allocated into units based on expected noise conditions for the estimated occupancy of the floor.

8. The method of claim 1, wherein the lighting sub-score is generated using a lighting model that projects light from a particular direction at a particular point corresponding to the unit.

9. The method of claim 1, wherein the score for each unit in the building is generated based on a location quality of a unit that incorporates a floor of the building that the unit is in and a location of the building that the unit is in.

10. The method of claim 1, wherein the user interface presents a progression of the layouts of the building over a plurality of iterations of the optimization function.

11. A system for building layout generation, the system comprising:
a hardware processor that is configured to:
receive building shape information and building constraint information for a layout of a building from a computing device, wherein the building comprises a plurality of floors;
generate a central corridor for the building;
divide, for each of the plurality of floors of the building, an area of a floor into a plurality of partitions by creating subdividing lines that connected from the central corridor to an exterior outline of the floor;
apply the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and
in response to determining that a stopping criteria has been reached in which the cumulative layout score between a current layout iteration and a previous layout iteration is less than a predetermined threshold value, cause a user interface to be presented on a computing device, wherein the user interface presents the optimized layout of units allocated to each floor of the building.

12. The system of claim 11, wherein the building shape information includes geometric information of the building and the building constraint information includes a number of types of different units that are to be included in the building.

13. The system of claim 11, wherein the hardware processor is further configured to determine unit mix information for the building based on location information of the building.

14. The system of claim 11, wherein the plurality of partitions are constructed such that a center of a first partition is a particular distance from a center of a second partition that is adjacent to the first partition and wherein the first partition and the second partition have different areas.

15. The system of claim 11, wherein the area of the floor is allocated into units by combining partitions having an area greater than a particular threshold to generate a set of first units and successively combining remaining partitions having an area less than the particular threshold to generate a set of second units.

16. The system of claim 11, wherein the area of the floor is allocated into units based on one or more adjacency factors indicating a preference to allocate particular unit types.

17. The system of claim 11, wherein the hardware processor is further configured to determine an estimate occupancy of the floor of the building, wherein the area of the floor is allocated into units based on expected noise conditions for the estimated occupancy of the floor.

18. The system of claim 11, wherein the lighting sub-score is generated using a lighting model that projects light from a particular direction at a particular point corresponding to the unit.

19. The system of claim 11, wherein the score for each unit in the building is generated based on a location quality of a unit that incorporates a floor of the building that the unit is in and a location of the building that the unit is in.

20. The system of claim 11, wherein the user interface presents a progression of the layouts of the building over a plurality of iterations of the optimization function.

21. A non-transitory computer-readable medium containing computer executable instructions that, when executed by a processor, cause the processor to perform a method for building layout generation, the method comprising:
receiving building shape information and building constraint information for a layout of a building from a computing device, wherein the building comprises a plurality of floors;
generating a central corridor for the building;
dividing, for each of the plurality of floors of the building, an area of a floor into a plurality of partitions by creating subdividing lines that connected from the central corridor to an exterior outline of the floor;
applying the building constraint information and the plurality of partitions into an optimization function to generate an optimized layout of units for the building that iteratively (i) allocates the area of the floor into units by combining a subset of the plurality of partitions based on the building constraint information, (ii) generates, for each unit in the building, a score for a unit that combines a lighting sub-score corresponding to an estimated amount of light expected to be received in the unit, a view sub-score corresponding to a location of the unit within the building, and a distance sub-score corresponding to proximity of the unit to one or more amenities; and (iii) combines the score for each unit of the floor in the building to generate a cumulative layout score for generated layouts including the allocated units in the building; and
in response to determining that a stopping criteria has been reached in which the cumulative layout score between a current layout iteration and a previous layout iteration is less than a predetermined threshold value, causing a user interface to be presented on a computing device, wherein the user interface presents the optimized layout of units allocated to each floor of the building.
